(19) United States
(12) Patent Application Publication
(10) Pub. No.: US 2009/0103099 A1
(43) Pub. Date: Apr. 23, 2009

(54) INTEGRATED SURFACE MODE BIOSENSOR

(75) Inventors: Peter Debackere, Gent (BE); Stijn Scheerlinck, Gent (BE); Roel Baets, Bachte-Maria-Leerne(Deinze) (BE); Peter Bienstman, Gent (BE)

Correspondence Address: CLARK & ELBING LLP, 101 FEDERAL STREET, BOSTON, MA, 02110, US

(73) Assignee: Interuniversitair Microelektronica Centrum, Leuven (BE)

(21) Appl. No.: 12/297,702

(22) PCT Filed: Apr. 19, 2007
(86) PCT No.: PCT/EP2007/003441

§ 371 Date: Oct. 20, 2008

Related U.S. Application Data
(60) Provisional application No. 60/792,966, filed on Apr. 19, 2006.

(51) Int. Cl. G01N 21/55; G01N 21/01

(52) U.S. Cl. 356/445; 356/244

(57) ABSTRACT

An optical detection system (100) for detecting biological, chemical or bio-chemical particles is described. The optical detection system (100) typically comprises a surface mode interference means. The surface mode interference means may comprise a layer (102) such as for example a metal layer like e.g. a gold layer. The surface mode interference means furthermore typically is adapted to create an interference effect between optical interface modes of the layer to detect optical changes in the vicinity of the layer (102). In this way, sample (106) occurring in the vicinity of the surface may be detected. The present invention furthermore relates to a method for performing optical detection and to a method for setting up an optical detection system wherein parameters are selected for tuning the surface mode interference means to a desired wavelength range and/or to a desired range of analyte refractive indices.

### TECHNICAL FIELD OF THE INVENTION

The present invention relates to methods and systems for biological, biochemical or chemical sensing and/or detecting of particles. More particularly, the present invention relates to methods and systems for biological, biochemical and/or chemical sensing and/or detecting of particles using surface mode measurements, like surface plasmon measurements.

### BACKGROUND OF THE INVENTION

The use of surface plasmon resonance (SPR) for biological and chemical sensing is well established. The high sensitivity of this technique to surface phenomena makes it ideal for use in real-time and label-free biosensors where very small changes in refractive index must be detected. Driven by the vision of a laboratory on a chip and its impact in numerous applications such as detection, bio sensing, kinetic and binding studies and point-of-care diagnostics, extensive work has been done to miniaturize SPR biosensors. In the past decade, several integrated optical SPR sensors have been demonstrated, in which thin gold films serving as a platform for the attachment of sensing films are deposited on top of an integrated optical waveguide system. However, all integrated SPR sensors that have been investigated so far typically have dimensions of wave guides and optical components that are too large for miniaturization and corresponding lab on chip applications. Typically current SPR sensors rely on phase-matching between a dielectric waveguide mode and a surface plasmon mode. Consequently the resonance wavelength or refractive index for which the device is at resonance is determined by the material system in which the device was fabricated. Due to this phase matching the waveguide mode becomes very lossy.

### SUMMARY OF THE INVENTION

It is an object of aspects of the present invention to provide alternative or good surface mode based, such as e.g. surface plasmon based, detection systems and methods. An advantage of embodiments of this invention is the provision of surface mode based detection systems, e.g. plasmon based detection systems, such as biosensors, biochemical sensors and chemical sensors that are small, e.g. fit in a lab-on-chip application. It is furthermore an advantage of embodiments of the present invention to provide surface mode based detection systems, e.g. plasmon based detection systems and methods that are highly tuneable. An advantage of embodiments of the present invention is the tuning of surface mode based detection systems and methods, e.g. surface plasmon based detection systems and methods, for example tuning them to desired wavelength ranges and/or to a desired range of analyte refractive indices. It is furthermore an advantage of embodiments of the present invention to provide a highly integrated optical detection system, e.g. a biosensor, bio-chemical sensor or chemical sensor. It is an advantage of embodiments of the present invention to provide a highly sensitive optical detection system, e.g. biosensor, biochemical sensor or chemical sensor. Detection of biological, chemical or biochemical particles may for example comprise applications in environmental applications, food safety applications, medical applications, etc. It is an advantage of embodiments of the present invention that a sensitivity that is comparable or better than state of the art devices based on measurement of bulk modes can be obtained. It also is an advantage of embodiments of the present invention to provide integrated detection systems that are relatively easy to manufacture. In other words, the systems may be used in and in combination with integrated optics.

The above objective is accomplished by systems and methods according to the present invention.

The present invention relates to an optical detection system for detecting biological, chemical or bio-chemical particles, the optical detection system comprising a surface mode interference means or surface mode interferometer wherein the surface mode interference means or surface mode interferometer comprises a layer and wherein the surface mode interference means or surface mode interferometer is adapted to create an interference effect between optical interface modes of an irradiation beam in said layer to detect optical changes in the vicinity of the layer or changes of thickness of adsorbed material at the interface between the material and the layer. The surface mode interference means or surface mode interferometer may support the surface modes. It may allow propagation of the interface modes. Interface modes may be formed in the surface mode interference means. The surface mode interference means or surface mode interferometer may be a surface plasmon means, e.g. a surface plasmon interference means or surface plasmon intereferometer. The layer may be a metal layer. The optical interface modes may comprise at least two optical interface modes. The layer may be a gold layer. The layer may be a silicide.

The optical interface modes may be decoupled optical interface modes of said layer. The optical interface modes may comprise at least an optical interface mode at a first side of the layer and an optical interface mode at a second side of the layer, opposite to the first side of the layer.

The optical detection system furthermore may comprise an irradiation source for generating an irradiation beam and/or a detector for detecting said interference of said optical interface modes.

The present invention also relates to a method for detecting biological, chemical or biochemical particles, the method comprising

bringing one side of a layer in contact with a sample

creating interfering optical interface modes of an irradiation beam in said layer

deriving from said interfering optical interface modes a presence of biological, chemical or biochemical particles in the vicinity of said layer.

The layer may be a metal layer.

The present invention furthermore relates to a method for setting up an optical detection system, the optical detection system comprising a surface mode interference means or surface mode interferometer having a layer, the method comprising selecting design parameters of the surface mode interference means or surface mode interferometer to generate an interference effect between optical interface modes of the layer. The surface mode interference means or surface mode interferometer may support the optical interface modes. It may allow propagation of the optical interface modes. Optical interface modes may be formed in the surface mode interference means or surface mode interferometer. The design parameters may comprise at least one of a material type of the layer, a thickness of a layer cladding region, a length of a layer cladding region, embedding the metal layer more or less in a high refractive index material, a material type of said high refractive index material, whether or not a grating is applied to reduce penetration depth of the surface mode in the sample medium.

The present invention also relates to a cartridge for use in an optical detection system for detecting biological, chemical or bio-chemical particles, the cartridge comprising a surface mode interference means or surface mode interferometer, wherein the surface mode interference means or surface mode interferometer comprises a layer and wherein the surface mode interference means or surface mode interferometer is adapted to create an interference effect between optical interface modes of an irradiation beam in said layer to detect optical changes in the vicinity of the layer or changes of thickness of adsorbed material at the layer. The surface mode interference means or surface mode interferometer may support the optical interface modes. It may allow propagation of the optical interface modes. Optical interface modes may be formed in the surface mode interference means. The present invention relates to an optical detection system for detecting biological, chemical or bio-chemical particles, the optical detection system comprising a surface plasmon resonance means or surface mode interferometer, wherein the surface plasmon resonance means or surface mode interferometer comprises a metal layer and wherein the surface plasmon resonance means or surface mode interferometer is adapted to create an interference effect between interface modes of an irradiation beam in said metal layer to detect optical changes in the vicinity of the metal layer or changes of thickness of absorbed material, e.g. absorbed layers, at the metal interface. Said optical changes may e.g. be changes in refractive index in the vicinity of the metal layer. Said irradiation beam may be provided by an irradiation source.

In the vicinity of the metal layer may mean being captured by capturing particles on the metal layer or in proximity to the metal layer. The surface plasmon mode that propagates at the top of the gold layer may sense refractive index changes up to the order of magnitude of 1.5 micrometers, e.g. up to 1.5 micrometer, away from the metal layer, e.g. gold layer. This distance may vary with metal selection and device structure selection. The chemical affinity of capturing particles, also called receptors, may be determining the sensitivity of the device.

The metal layer may be a gold layer. The interface modes may be decoupled interface modes of said metal layer.

The system may comprise a waveguide made of high refractive index material having first regions and a second region, whereby the metal layer is in close proximity with a first region of the waveguide.

In close proximity may mean that the metal layer is in direct contact with the waveguide. Preferably the metal and the waveguide material may be sufficiently close to induce cut off in the waveguide. This cut-off condition may also be determined by the thickness of the waveguide and the index contrast between the waveguide material and the cladding layers beneath the waveguide.

The system may comprise a waveguide made of high refractive index material having a first region and second regions, wherein the metal layer is at least partly embedded in a first region of the waveguide. The metal layer may be completely embedded in the second region of the waveguide made. The surface of the metal layer may be in line with the surface of said waveguide. The surface of the metal layer may also be lower than the surface of neighbouring waveguide regions where no metal layer is present.

Preferably the surface of the metal layer adapted to be in contact with the sample thus is not in contact with the waveguide material. The waveguide made of high refractive index material may be a silicon waveguide.

The silicon waveguide may be part of a silicon on insulator structure. Preferably, mode cut-off may be induced in the waveguide. The mode cut-off in the waveguide may result in said first region of the waveguide having no own propagating mode near the metal layer. The coupling loss between second regions and first region of the waveguide may be lower than −15 dB, preferably lower than −12 dB, more preferably lower than −10 dB, even more preferably lower than −8 dB. The metal layer may have a surface suitable for being contacted with a sample, wherein the coupling loss to a surface plasmon mode at the surface opposite to the surface suitable for being contacted with a sample may be less than −7 dB, preferably less than −6 dB, more preferably less than −5 dB. The coupling loss to the external plasmon mode, i.e. the plasmon mode influenced most by the sample, preferably may be larger than the coupling loss to the internal plasmon mode, i.e. the plasmon mode influenced least by the sample. In other words, preferably more power may be coupled to the internal plasmon mode than to the external plasmon mode.

The present invention also relates to a method for detecting biological, chemical or biochemical particles, the method comprising bringing one side of a metal layer in contact with a sample, creating interfering interface modes of an irradiation beam in said metal layer, and deriving from said interfering interface modes a presence of biological, chemical or biochemical particles in the vicinity of said metal layer. Creating interfering interface modes of an irradiation beam in said metal layer may comprise providing an irradiation beam in a waveguide comprising said metal layer and generating decoupled interface modes of said irradiation beam in said metal layer.

The method further may comprise providing propagation mode cut off in regions of the waveguide where interface modes are generated.

The method may comprise coupling an irradiation beam propagation mode to decoupled interface modes with a coupling loss of less than −15 dB, preferably less than −12 dB, more preferably less than −10 dB, even more preferably less than −8 dB.

The present invention also relates to a method for setting up an optical detection system, the optical detection system comprising a surface plasmon resonance means or a surface plasmon resonator having a metal layer, the method comprising selecting design parameters of the surface plasmon resonance means or surface plasmon resonator to generate an interference effect between interface modes of a metal layer.

The design parameters may comprise at least one of a material type of the metal layer, a thickness of the metal layer cladding region, a length of a metal layer cladding region, if applicable, embedding the metal layer more or less in a high refractive index material, a material type of said high refractive index material, whether or not a grating is applied to reduce penetration depth of the plasmon mode in the sample medium.

The design parameters may be selected in order to tune to a specific wavelength to be used.

The method furthermore may comprise to a computer program product for executing a method for designing a detection system as described above, to a data carrier carrying such a computer program product or to transmitting such a computer program product over a network.

The design parameters may be selected in order to tune for a specific refractive index range or a specific thickness range for a sample to be detected.

Particular and preferred aspects of the invention are set out in the accompanying independent and dependent claims. Features from the dependent claims may be combined with features of different independent claims and with features of other dependent claims as appropriate and not merely as explicitly set out in the claims.

It is an advantage of embodiments of the present invention that real-time and label-free biosensors can be obtained.

It is an advantage of embodiments of the present invention based on high refractive index material systems such as silicon-on-insulator, that requirements for high-level integration and high-throughput fabrication can be obtained.

It is an advantage of surface plasmon resonance devices and methods according to embodiments of the present invention that they operate based on the principle of an interference effect between two plasmon modes. It is also an advantage of embodiments of the present invention that coupling of a dielectric waveguide mode to both surface plasmon modes is achieved.

It is an advantage of embodiments according to the present invention that lab-on-chip devices can be obtained having a number of applications such as detection, bio-sensing, kinetic and binding studies and point-of-care diagnostics Although there has been constant improvement, change and evolution of devices in this field, the present concepts are believed to represent substantial new and novel improvements, including departures from prior practices, resulting in the provision of more efficient, stable and reliable devices of this nature.

The teachings of the present invention permit the design of improved methods and apparatus for optical biosensors.

Other features and advantages of the present invention will become apparent from the following detailed description, taken in conjunction with the accompanying drawings, which illustrate, by way of example, the principles of the invention.

These and other objects and features of the present invention will become better understood through a consideration of the following description taken in conjunction with the drawings.

### BRIEF DESCRIPTION OF THE DRAWINGS

FIG. 1a is a schematic representation of a surface mode detector device as can be used in embodiments according to the present invention.

FIG. 1b is a schematic representation of a SPR detector device as can be used in embodiments according to the present invention.

FIG. 2 is a graphical representation of the dispersion of effective indices of the guided modes as a function of the waveguide thickness, as can be used in embodiments according to the present invention.

FIG. 3a indicates the coupling loss to surface plasmon modes as a function of the waveguide thickness, as can be used in embodiments according to the present invention.

FIG. 3b indicates the propagation loss as a function of buried oxide thickness for a device as schematically represented in FIG. 1b.

FIG. 4 is a schematic representation of the light transmission in a device as shown in FIG. 1, with a structure length of 10 μm.

FIG. 5 is a schematic representation of the light transmission as function of the wavelength in a device as shown in FIG. 1b.

FIG. 6 is a schematic representation of the shift in resonance wavelength as a function of the refractive index of the sample medium, as can be obtained with a device according to an example of an embodiment of the present invention.

FIG. 7 is a schematic representation of the shift in resonance wavelength as a function of the thickness of the adsorbed layer, according to an example of an embodiment of the present invention.

FIG. 8a to FIG. 8f illustrate real and imaginary parts of the refractive index as function of wavelength for exemplary layer material used to illustrate the properties of the device according to embodiments of the present invention.

FIG. 9a and FIG. 9b illustrate a comparison between experimental and simulated results for an exemplary device as schematically illustrated in FIG. 1, according to an embodiment of the present invention.

FIG. 10a to FIG. 10h illustrate simulated transmission spectra for a device according to embodiments of the present invention.

### DESCRIPTION OF THE PREFERRED EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

The following terms or definitions are provided solely to aid in the understanding of the invention. The systems and methods are based on surface mode measurements such as e.g. surface mode interference measurements. The surface mode measurements may comprises surface plasmon measurements, such as e.g. surface plasmon resonance measurements, but whereby interference of the surface plasmons is detected. The latter therefore also may be referred to as surface plasmon interference measurements. Interface or surface modes do not include wave guide modes such as dielectric wave guide modes. The interface modes are optical interface modes. Detecting of biological, chemical or biochemical particles may comprise applications in biological sensing, chemical characterisation, environmental applications, food safety applications, health applications, diagnostic applications, etc. The term “sample”, as used herein, relates to a composition which may comprise at least one analyte of interest. The sample is preferably a fluid, also referred to as “sample fluid”, e.g. an aqueous composition. The sample may be a gas or a liquid. The term “analyte”, as used herein, refers to a substance whose presence, absence, or concentration is to be determined according to the present invention. Typical analytes may include, but are not limited to chemical substances, small organic molecules, metabolites such as glucose or ethanol, proteins, peptides, nucleic acid segments, molecules such as small molecule pharmaceuticals, antibiotics or drugs, molecules with a regulatory effect in enzymatic processes such as promoters, activators, inhibitors, or cofactors, viruses, bacteria, cells, cell components, cell membranes, spores, DNA, RNA, micro-organisms and fragments and products thereof. Presence, absence or concentration of the analyte may be determined directly by assessing the presence, absence or concentration of the analyte itself, or may alternatively be determined indirectly by assessing the presence, absence or concentration of a target or target molecule.

The present invention is related to a system using interface mode measurements. For the purpose of the present invention the terms “interface mode” and “surface mode” and the terms “interface” and “surface” will be interchangeable, both referring to modes coupled to the surface of a layer, i.e. to the interface formed between the layer and an object surrounding the layer, which may be a substrate, another material, air, a sample, etc.

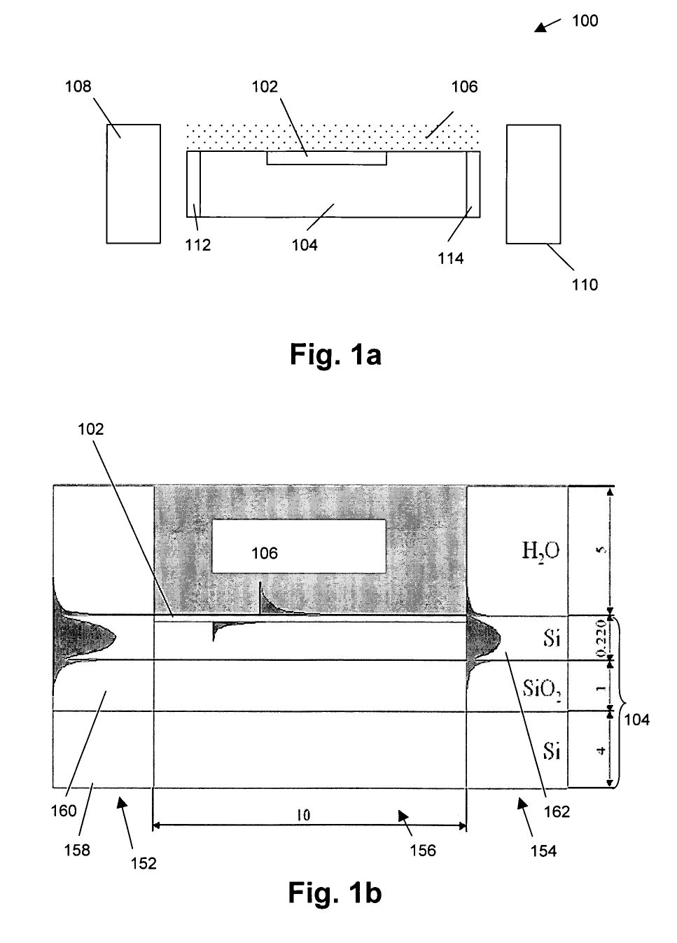

In a first aspect, the present invention relates to a detection system, e.g. sensor or an analytic device, using interface mode measurements such as e.g. surface plasmon measurements. A schematic representation of such a detection system is shown in FIG. 1a. The detection system comprises a layer 102 adapted for supporting or propagating optical surface modes, the layer being in contact with or embedded in an optical wave guide 104. The layer can be contacted with sample 106. Irradiation from an irradiation source 108, which may be part of or may be separate from the detection system, can be coupled in the device whereby surface modes are generated or propagated by the layer 102. The transmitted signal, can be detected with a detector 110, which may be part of or separate from the detection system. Coupling means or coupler 112, 114 for coupling or improving coupling to and from the waveguide may be provided. Such coupling means or coupler may comprise optical fibres, gratings, etc. The system will further be described in more detail.

In this first aspect, the surface mode based detection system, e.g. plasmon based detection system 100, is adapted to use an interference effect of the interface modes of a layer 102, e.g. a metal layer like a thin gold layer, to detect refractive index changes in the vicinity of the layer or changes of thickness of adsorbed material, e.g. adsorbed layers, at the layer surface. The system 100 may comprise an irradiation source 108. An irradiation source 108 also may be external to the detection system. Such an irradiation source 108 typically may be adapted to provide an irradiation beam in the layer. The irradiation beam may occur in the layer 102 at least partly as surface modes, i.e. interface modes, of the irradiation beam. The irradiation source 108 may be either monochromatic or broad band source, depending on the operating regime as will be described further. The irradiation beam may be an electromagnetic beam, e.g. a light beam. The irradiation beam thus may, when coupled into the surface mode interference means or surface mode interferometer, which also could be referred to as surface mode propagation means, at least partly be present in the layer 102 as surface modes. The interface modes used thereby may be decoupled interface modes of the layer 102, e.g. metal layer. The layer 102 may be any suitable layer supporting or generating surface modes of the irradiation. The layer 102, e.g. metal layer may be any suitable layer, such as a gold layer or a silver layer. The layer also may be a layer having similar properties to that of metal layers, such as e.g. silicides like cobaltdisilicide. The material used may be selected based on its compatibility with the material to be detected. The decoupled interface modes may be a surface mode at the top surface/interface of the layer, e.g. metal layer, and a surface mode at the bottom interface of the layer, e.g. metal layer. i.e. a surface mode at the top interface between the layer, e.g. metal layer and the sample and a surface mode at the bottom interface between the layer, e.g. metal layer, and another material, e.g. a high refractive index dielectric material. Such decoupled interface mode at the side of the layer, e.g. metal layer, adapted for being in contact with the sample may be referred to as the external surface mode, whereas a decoupled interface mode at the side opposite to the top of the layer may be referred to as internal surface mode.

The decoupled interface modes at both interfaces of the layer may be obtained by surrounding the layer 102 by two dielectric material having substantially different dielectric constants. Optionally the layer is at one side, typically referred to as the top side, adapted for being contacted with sample 106. For sensing purposes, the sample surface may be modified to receive sample particles to be detected. The sample 106 may e.g. be functionalised with bio-molecular recognition elements, such as e.g. capturing probes. The layer 102 furthermore may be at another side, optionally opposite to the top side, in close proximity of, in contact with or embedded in a dielectric layer having a high refractive index, such as e.g. a silicon layer, functioning as a wave guide or being part of a substrate 104. Such a substrate may be planar or may have a different shape, e.g. be a fibre. With high refractive index there is meant a substantial difference in refractive index between the guiding layers and the cladding layer. In the case silicon is used, the propagating layer in silicon and the cladding layer is silicon dioxide. So high index contrast means that the refractive index of the wave guide layer is substantially higher than the refractive index of the so-called cladding layers (which include all the layers surrounding the wave guide, so the silicon dioxide layer and the analyte layer in top) The high refractive index contrast ensures tight confinement of the optical power to the wave guide, however this is not a necessary condition for the operation of this device. As shown in the examples the principle also works for a Au layer embedded in an InP heterostructure (InGaAsP(Q=1.22, n=3.37) on InP (n=3.17)). Although there is a fairly low index contrast between core and cladding, the principle still holds. The high refractive index may e.g. be larger than 2 refractive index units (RIU), e.g. be larger than 2.5 refractive index units (RIU) or e.g. be larger than 3 refractive index units (RIU). Preferably the layer 102 may be embedded in the dielectric layer. The dielectric layer typically functions as a waveguide. Bringing the layer 102 in close proximity, in contact with or embedding it in a substrate 104 such as e.g. a waveguide may be performed by bringing the layer in close proximity, in contact with or embedding it in a first region of the waveguide. The first region of the waveguide may be a central region of the waveguide, whereby the waveguide may also have second regions adjacent to the central region for coupling a waveguide mode to and from the first central region. Embedding a layer 102 in the waveguide also may be expressed as providing a layer clad region in the waveguide. The layer 102 may be fully embedded, such that e.g. only the top surface, adapted for contacting the sample is not surrounded or in contact with the waveguide. In the latter case, the layer 102 has a top surface that is in line with the surface of the second region of the waveguide. The top surface of the layer also may be positioned outside the plane of the surface of the second region of the waveguide, e.g. lower than the surface of the waveguide whereby the cross-section sides of the layer may be completely in contact with the waveguide material, or higher than the surface of the second region of the waveguide, e.g. whereby the layer is positioned at least partly on top of the waveguide. The thickness of the layer clad region may extend to the full thickness of the waveguide, thus resulting in no waveguide material being present anymore in the first region. The thickness of the layer clad region also may be smaller. If a silicon layer is used as high refractive index material, it may be part of a silicon-on-insulator material system. Alternatives dielectric layer also may be used, without leaving the scope of the present invention. In other words, the layer is surrounded by two layers having a substantially different dielectric constant, or in other words a substantially different refractive index, may for example differ at least 0.5 refractive index units (RIU), e.g. at least 1 refractive index units (RIU) or e.g. at least 1.5 refractive index units. The latter thus may be one way to obtain decoupled interface modes in a first central region of the waveguide. The obtained structure may be a substantially parallel structure whereby the structure is built up as a layer structure. It may be based on a flat substrate. In one embodiment, the obtained structure also may be different from parallel, e.g. in a fiber based shape. The layer then can be embedded in or in close contact on the core of a fiber wherein irradiation can be coupled in and out. It may be an advantage of such a structure that irradiation can be coupled in and/or out of the fiber in an efficient way.

The detection system may be adapted such that mode cut-off occurs in the waveguide. In other words, the layer may be adapted such that the waveguide has no waveguide mode of its own anymore in the first region of the waveguide, or in other words that there is no propagation mode in the first region of the waveguide. The only two existing modes in this first region then may be interface modes. Alternatively, the mode of the waveguide mode also may be substantially suppressed, such that the contributions to the interface modes are sufficiently large to derive optical changes in the vicinity of the layer there from. The detection system also may be adapted such that coupling loss between first regions and second regions of the waveguide may be lower than −15 dB, preferably lower than −12 dB, more preferably lower than −10 dB, even more preferably lower than −8 dB. For the coupling loss to the internal surface plasmon mode, the coupling loss may be less than −7 dB, preferably less than −6 dB, more preferably less than −5 dB. In other words, efficient coupling between the propagation mode in second regions of the waveguide to interface or surface plasmon modes in the first region may be obtained.

In general, by using interference effects of the interface modes, e.g. decoupled interface modes, optical changes, such as e.g. a change in refractive index, can be measured, which may be indicative of the presence of sample or sample in a fluid environment in the vicinity of the layer, e.g. metal layer. Also changes of thickness of adsorbed material, e.g. adsorbed layers, at the interface may be sensed. In order to detect the interference effects of the decoupled interface modes, a detector unit may be provided for detecting the output signal after passing through the metal layer, thus allowing detection of the interference effects. Any suitable detector may be used, such as e.g. an optical detector element. Furthermore a processing system may be provided for interpreting the detector results.

Typically a sensor length in the range having an upper limit of 500 μm, possibly 100 μm, also possibly 50 μm, further possibly 25 μm and a lower limit of 0.3 μm, possibly 1 μm, possibly 2 μm, possibly 5 μm typically may be used, although the invention is not limited thereto and other lengths, not within this range may be applied, depending on the materials and wavelengths used. The above wavelength ranges may be selected when using silicon-on-insulator technology and telecommunication wavelength ranges. Typically, for different operating regimes, which will be discussed later, a sensor length of for example 10 μm may be used, which is two orders of magnitudes smaller than current integrated surface plasmon sensors. In other words, a substantial miniaturization may be obtained with embodiments according to the present invention.

A possible principle of operation, the invention not being limited thereto, is depicted with reference to FIG. 1b. The layer 102 may be in contact with a dielectric material, whereby an incoming dielectric mode will couple to two interface modes, e.g. surface plasmon modes. In the setup shown in FIG. 1b, the layer 102 is a metal layer embedded in a silicon on insulator substrate 104, comprising a top silicon layer 152, a buried oxide layer 154 being a silicon oxide layer SiO₂ and a further silicon layer 156. The optical transmission of this element typically may be entirely determined by interference of two such isolated interface modes, e.g. surface plasmon modes, propagating in the layer i.e. the metal layer 102 being a gold layer in the present example. Whereas the external interface mode, e.g. external plasmon mode, demonstrates a highly sensitive response to a change in the refractive index of the sample medium, the internal interface mode is virtually insensitive to sample-media variations. At the end of the sensing region both modes may couple back to the dielectric waveguide mode and, depending on their relative phase experience destructive or constructive interference. The resulting signal may allow to determine whether sample material is present in the vicinity of the metal layer. In other words, the detection system may be based on transmission of energy that is very sensitive to changes in the refractive index of the environment. It thus may be e.g. sensitive to the addition of particles, e.g. addition of a protein layer, as will be further illustrated with simulations. For example, we obtain a theoretical limit of detection of 10⁻⁶ refractive index units (RIU) for a metal layer of length 10 μm.

An exemplary simulation setup of a detection system according to FIG. 1b thus may consist of two wave guiding sections (regions 152 and 154 on the figure) corresponding with second regions as described above, and a sensing region (region 156) corresponding with a first region as described above. In the present example, the substrate 104 comprises waveguide sections consisting of a 4 μm thick Si-substrate layer 158 covered with a 1 μm thick SiO₂ layer 160. This substrate supports a Si waveguide 162 of 220 nm thick. The sensing region also consists of a 4 μm thick Si substrate layer 158, a 1 μm thick SiO₂ layer 160, a 160 nm thick Si layer 162 and a 60 nm thick Au layer 102. For sensing purposes the Au layer may be functionalised with bio-molecular recognition elements. It will be clear that the specific thickness provided for this example are only exemplary, and not limiting for the present invention.

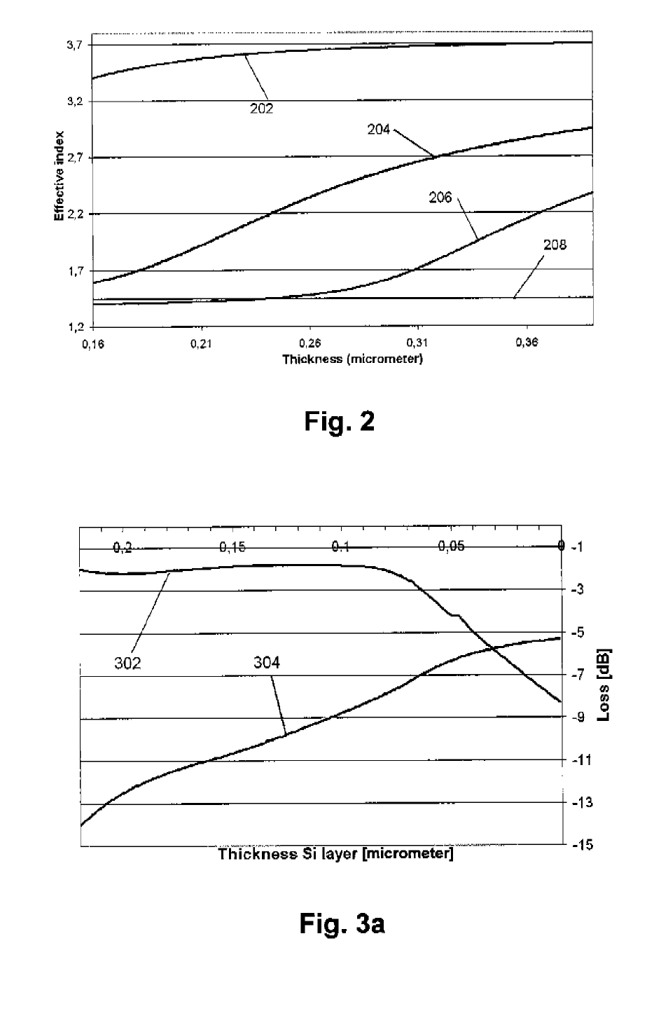

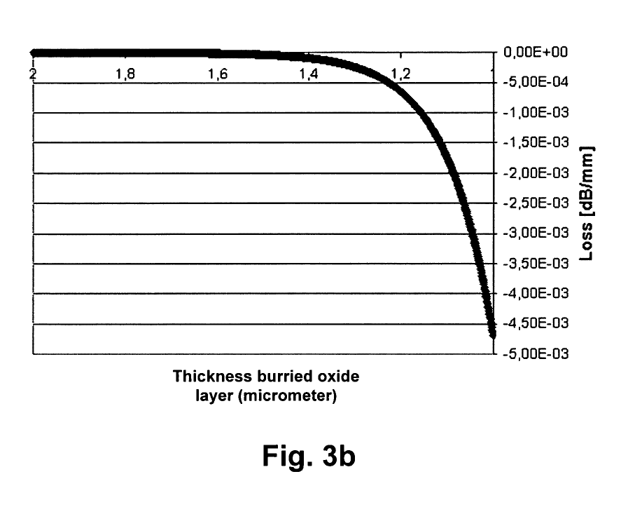

The above principle of coupling from a dielectric waveguide mode to interface modes such as for example surface plasmon modes is, by way of example, studied in more detail—the invention not being limited thereto—for a silicon waveguide and a silicon waveguide comprising an embedded layer in the present example being a metal layer, i.e. gold layer. In FIG. 1b the simulated dependence of the effective indices of the waveguide modes of the thickness of the silicon waveguide is shown, for a regular silicon waveguide and a waveguide with a thin gold layer (60 nm) on top. While the unclad waveguide has a guided mode for all thickness indicated in FIG. 1b, one can see that the gold-clad waveguide has a cutoff thickness of approximately 236 nm, below this thickness no dielectric guided mode exists. On FIG. 2 one can also see the dispersion relation of the internal surface plasmon mode. Since a waveguide of thickness 160 nm does not support guided modes, more particularly a first region of a waveguide with thickness 160 nm does not support guided modes, the only two guided modes which exist in the gold-clad waveguide are surface plasmon modes, one at each interface of the gold layer. In the example shown, a 60 nm gold layer is embedded in a 220 nm thick waveguide, thus resulting in a 160 nm waveguide left. FIG. 2 indicates the internal surface plasmon mode 202, the guided mode for the case an unclad waveguide 204 would be used, the guided mode for the gold clad waveguide 206 and the lightline for silicon 208. The graph shows that internally only the internal surface plasmon mode is a guided mode. Internal surface plasmon mode 202 does never go below the lightline of Si for all Si thicknesses which means that this is always a guided mode. Guided mode 204 is a regular guided mode in a Si slab waveguide if no metal cladding is present and is shown on this graph as comparison. One can also see that this is always a guided mode (at least up until a waveguide thickness of 160 nm, for thinner waveguide layers this mode will also cross the light line and become radiating). Wave guide mode 208 is the waveguide mode in a Si slab wave guide if a metal layer is present. This means that e.g. at a waveguide thickness of 360 nm two guided modes will be present, the internal surface plasmon mode and a waveguide mode in the Si layer. The latter is not an ideal situation for an interferometer since in this case all the power transferred to the regular waveguide mode will be useless. However if the thickness of the Si layer is reduced, the waveguide mode will go from guided to radiating, which means that the only mode that is guided, so the only mode that carries power in the propagation direction is the internal surface plasmon mode. So by reducing the thickness of the Si layer we get rid of a second mode in the Si which would otherwise degrade the performance of our device. Therefore it is preferred that the waveguide mode lies below the lightline of Si. It is to be noted that all modes with an effective index below the lightline are so-called radiating modes, they do not carry optical power in the propagation direction, instead power coupled to these modes will be ‘radiating’ away from the waveguide and is essentially lost. In FIG. 3a, by way of example, the coupling losses in dB from the silicon waveguide mode to the surface plasmon mode is shown. The graph shows the coupling loss as function of the thickness of the structure. In the example shown, the waveguide from which we couple light into the structure has a thickness of 220 nm, the thickness of the gold-clad waveguide varies between 220 and 0 nm. For a thickness, of 220 nm, the metal is positioned on top of the waveguide, whereas for 0 nm, a region of the waveguide is completely replaced by the metal layer. This indicates that the metal surface can be in line, but the metal surface can also be lower than the waveguide, it is fully embedded in the waveguide whereby only the top surface of the metal layer is not in contact with waveguide material. By choosing the waveguide thickness appropriately one can reduce the coupling loss from the input waveguide to the external surface plasmon mode from approximately −17 dB, to about −5 dB, the coupling loss to the internal plasmon mode varies between −1, 79 dB and −8 dB. The coupling loss to the external plasmon mode preferably may be larger than the coupling loss to the internal plasmon mode. in FIG. 3b the propagation loss is shown of the zeroth order TM polarized mode in a Si slab waveguide with a thickness of 220 nm. One can see that the substrate leakage (which should be kept as low as possible to get a good performance) can be decreased by increasing the thickness of the buried oxide layer. Substrate leakage thereby means that optical power is coupled from the wave guide to the substrate, which is in the vicinity of the wave guide. This optical power is lost for the application. By using a thick buried oxide layer we can ensure that all optical power remains in the waveguide and does not get transferred to the underlying substrate where this power would be essentially lost.

Sensing systems or detection systems according to embodiments of the first aspect of the present invention have the advantage of being highly customizable. A set of design parameters may be tuned in order to tune the operation of the sensor to desired wavelength ranges and/or to a desired range of analyte refractive indices. Embodiments according to the first aspect of the present invention furthermore can be operated in two different regimes. A monochromatic incoming mode may be used whereby the power at the end of the structure is monitored as a function of the refractive index of the overlying layer. The latter may be referred to as an intensity-based approach. The optical detector used in such system thus may be a power detector, detecting the intensity of the irradiation beam. Alternatively, in a second regime, a relatively broadband incoming mode is used, and the position of the minima in the transmission curve is monitored as a function of the refractive index of the sample-medium. The latter will be referred to as the wavelength-based approach. This may be the usual operating regime for surface plasmon resonance sensors, although the other regime also may be used and thus is described as well. The optical detector used in such a system may be a spectral detector, allowing to detect the intensity as function of the wavelength.

In a second aspect, the present invention also relates to a corresponding method for detecting biological, chemical or bio-chemical particles, for example—but not limited to—using a system as described above.

In further embodiments, the detection systems according to the first aspect and the methods for detecting according to the second aspect may be further enhanced with respect to their sensitivity. The latter may e.g. be performed by coupling more power to the external surface mode, e.g. external plasmon mode. Another feature that can be used for enhancing the sensitivity may be the introduction of structures in the metal, such as e.g. nano-particles, gratings, etc. or to use corrugated metal surfaces. These features typically allow to improve the sensitivity by enlarging the fields near the layer surface, e.g. enhancing the electric field near the surface of the layer, e.g. metal layer.

In a third aspect, the present invention relates to a method for setting up a sensor using surface plasmon resonance measurements, e.g. a biosensor, a biochemical sensor or a chemical sensor. The performance of the device can be tuned by selecting appropriate design parameters. A set of design parameters may e.g. be selected or tuned in order to tune the operation of the sensor to desired wavelength ranges and/or to a desired range of analyte refractive indices. Parameters that can be used for tuning the resonance may e.g. be the length, the extent of embedding the layer, e.g. metal layer, in the dielectric layer with high refractive index, the thickness of the layer, e.g. metal layer, used e.g. the thickness of the gold layer used, the type of layer, e.g. metal layer, selected i.e. for example the material selected like e.g. gold, the length of the gold-clad waveguide section. Other parameters that may be used are the selection of dimensions of the gold clad waveguide, e.g. up to the situation where these become much smaller than the dimensions of the incoming silicon waveguide sections. Tuning these parameters allows to tune for which wavelength or for which refractive index one wants the structure to be at resonance. A parameter that may be used to tune the sensitivity may be the amount and ratio of grating regions introduced, e.g. the ratio of metal gratings/dielectrum gratings, e.g. gold gratings/silicon gratings and the presence and amount of grating sections in the sensing layer, e.g. metal layer, e.g. gold layer. Tuning may be done based on simulation and/or experimental results, e.g. based on simulations. The tuning may be done in an automated way, e.g. based on an algorithm performed on a processor.

In further aspects, the present invention also relates to a processing means or processor, in as far as the processing means or processor is adapted for performing the method of setting up or designing as described above. Furthermore, typically these steps are performed based on an algorithm running on the processing means or processor by way of commands. Accordingly, the present invention includes a computer program product which provides the functionality of any of the methods according to the present invention when executed on a computing device. Further, the present invention includes a data carrier such as a CD-ROM or a diskette which stores the computer product in a machine readable form and which executes at least one of the methods of the invention when executed on a computing device. Nowadays, such software is often offered on the Internet or a company Intranet for download, hence the present invention includes transmitting the computer product according to the present invention over a local or wide area network. The computing device may include any suitable computing system or device such as a microprocessor, either in the form of a computer or in an embedded device or a digital logic device such as a programmable logic array (PLA), PAL, FPGA, etc.

In the following, a number of simulation results for the above described exemplary structure will further be presented, thus illustrating different advantages of embodiments according to the present invention.

The structure was simulated with an in house-developed eigen-mode solver (CAMFR). The calculation algorithm consists of two steps. A Fourier Modal Method algorithm, which was recently improved by adding an adaptive spatial resolution at the discontinuity points of the refractive index profile, generates estimates for a Mueller algorithm which calculates the modes exactly. In this example, the refractive index used was 3.45 for Si and 1.45 for SiO₂. The refractive index used for gold depends on the wavelength of the light, as typically metal have a very dispersive refractive index. A theoretical fit to experimental data was used for the refractive index of gold as shown in Palik “Handbook of optical constants of solids”, Academic Press, 1998.

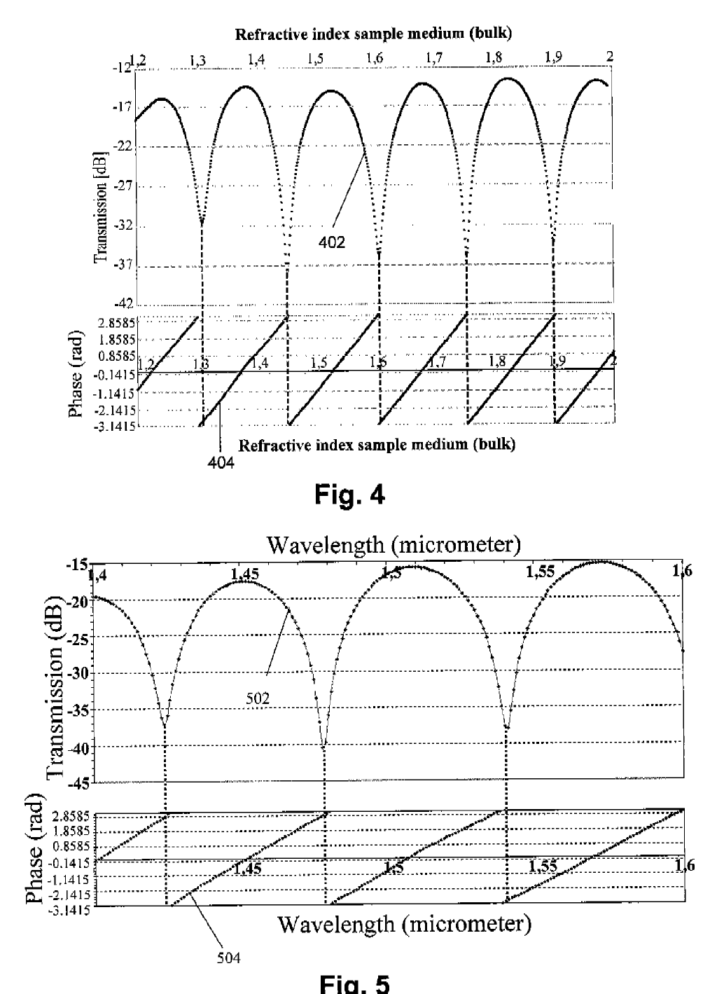

FIG. 4 shows the transmission 402 and phase dependence 404 for a 10 μm long sensing structure as a function of the refractive index of the sample medium. The position of the occurring peaks can be calculated from the phase dependence of both the external and the internal surface plasmon mode. One can clearly see that the position of the minima in the response corresponds to a phase difference of π of both interacting waves. The latter illustrates that the response of the detection system indeed is an interference effect, as described above.

It can be calculated that the maximum sensor sensitivity for this device already reaches values of 4000 dB per RIU (refractive index unit). In conjunction with an opto-electronic system which can measure changes in the optical power of 0.01 dB, variations in the refractive index as small as 10⁻⁶ can be measured. So the resolution of this device is comparable with typical other integrated surface plasmon sensors, whereby the dimensions however typically are two orders of magnitude smaller. This means that the smallest amount of a certain molecule that can be detected will also be two orders of magnitude smaller than for current integrated surface plasmon sensors. It furthermore is to be noted that further optimization of the design may be performed as described in the designing aspect according to the present invention, such that even a higher sensitivity and resolution may be obtained.

The following results were obtained by simulating the response of the detection system when it is excited by a broadband incoming waveguide mode. The exemplary structure as shown in FIG. 1b and as described in more detail has been used. If we set the refractive index of the sample medium to 1.33 and vary the frequency of the exciting waveguide mode, the transmission of this structure shows the behavior that is shown in FIG. 5, indicating both the transmission 502 and the phase dependence 504 as function of the wavelength used. This behavior also may be explained by plotting the phase difference between the internal and the external plasmon modes.

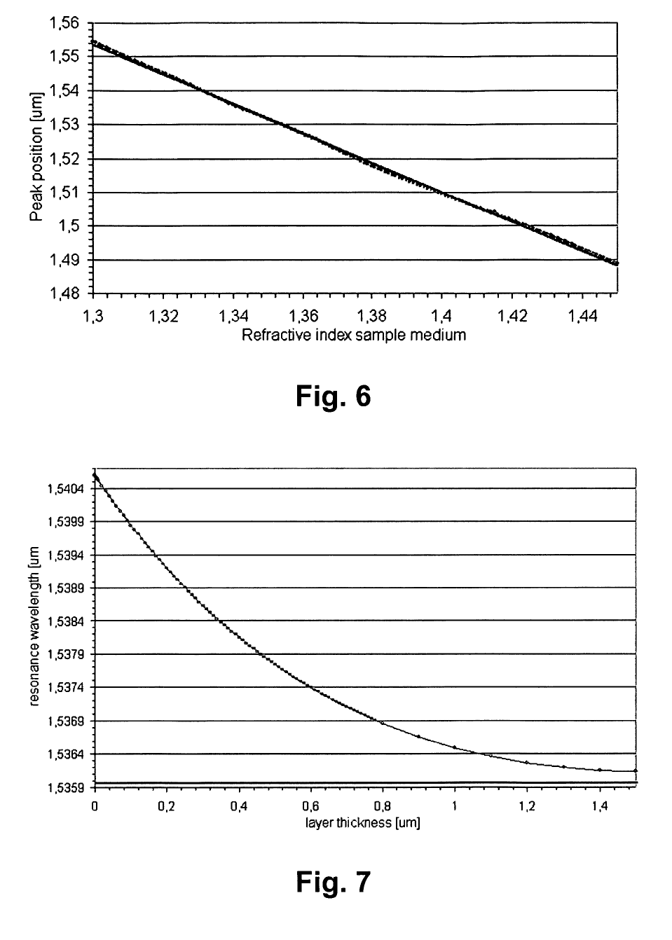

To study the performance of this SPR detection system we have calculated the sensitivity of this structure as a function of bulk refractive indices and as a function of the thickness of the sample medium. We do this by calculating Δλ/RIU for a bulk refractive index change of the sample medium and by calculating the dependence of the wavelength shift on the thickness of the sample-medium respectively. One can see from FIG. 6 that the shift of the resonance wavelength as a function of the refractive index of the sample medium is equal to 463.5 nm per refractive index unit.

To determine the influence of the layer thickness on the shift of the resonance wavelength, we have determined the resonance wavelength for adsorbed layer thickness in a large thickness range. The shift of the resonance wavelength varies from 8 pm/RIU for very thin layers and layers up to approximately 10 nm, it then has a value of 6 pm/RIU for a quit large range, and it slowly decreases for very thick layers. The refractive index of this adsorbed layer was equal to 1.34. By way of illustration, without being limited by theory, an interpretation for the tuneability of the detection systems is discussed, the invention not being limited thereto. Several tuning parameters can be used. In the following example, it will be illustrated that the peaks of the spectrum can be shifted into any possible region by varying the length of the structure, whereby the response of the structure can be optimized by introducing grating regions at the beginning and the end of the sensing region. These remarks are valid for both modes of operation of the sensor.

It first is illustrated that by varying the length of the sensing region, one can tune the depth of the minima, and the position of the peaks. Since the effect is an interference effect, destructive interference will take place when the following condition is fulfilled

|φ_{T12(intern,in)}+φₚᵣₒₚᵢₙₜₑᵣₙ+φT_{12(in,intern)})−(φ_{T12(extern,in)}+φₚᵣₒₚₑₓₜₑᵣₙ+φ_{T12(in,extern)})∥˜π [1]

where φ_{T12(intern,in)} is the phase difference due to the coupling of the incoming waveguide mode to the internal plasmon mode, φ_{propagationintern} is the phase due to the propagation of the internal plasmon mode along the sensing region, and φ_{T12(in,intern)} is the phase difference due to the coupling of the internal plasmon mode to the dielectric waveguide mode. Because of reciprocity the phase difference due to the coupling of the incoming waveguide mode to the internal plasmon mode equals the phase difference due to the coupling of the internal plasmon mode to the dielectric waveguide mode, i.e. φ_{T12(intern,in)}=φ_{T12(in,intern)}. Similar definitions hold for the external plasmon mode. Equation 1 completely determines the position of the minima in the transmission curve.

To achieve total destructive interference the losses along each path should be the same, so that at the end both interacting modes carry the same amount of power. Depending on the wavelength for which one would want the transmission to reach a minimum, it is quite straightforward to prove that the optimal length is given by

$$L = \frac{1}{{k}_{\_}^{external} - {k}_{i}^{internal}} \frac{1}{log e} log ( \frac{{\vert T ( intern , in ) \vert}^{2}}{{\vert T ( extern , in ) \vert}^{2}} ) \qquad [ 2 ]$$

where kᵢ^{internal} and kᵢ^{external} are the imaginary parts of the k-vector of the internal and the external plasmon mode, and where T(intern, in) and T(extern, in) are the transmission coefficients of the incoming dielectric mode to the internal and the external plasmon modes. It may be noted that typically all of the values used in the above formulas, i.e. all the φ's except φₚᵣₒₚ and +φₚᵣₒₚₑₓₜₑᵣₙ and all the T's, which are phases and amplitudes of coupling coefficients, may depend on the coupling of the waveguide mode to both plasmon modes. So all these values typically may depend on the thickness of the Si waveguide in the metal-clad region, the thickness of the metal and the presence of coupling regions such as e.g. gratings.

So by varying the sensor length, one can simultaneously change the position of the minima, by altering the phase due to the propagation of the internal plasmon mode along the sensing region φₚᵣₒₚ, and the depth of the minima, since there is only one length for which destructive interference is total. If the length of the device would be the only parameter one could vary it would be impossible to satisfy both equations, however, we can also influence the coupling of the waveguide modes to the plasmon modes, and by varying the thickness of the gold layer we can modify the coupling coefficients and the loss of the plasmon modes.

The influence of the coupling coefficients is illustrated below. From equation [2] one can see that it's possible to decrease the sensor length, for a given resonance position. We simply have to minimize the ratio |T(extern,in)|²/|T(intern,in)², which can be achieved by providing coupling sections at the beginning and the end of the sensing region. Maximizing the coupling between the incoming waveguide mode and the external plasmon mode should result in a smaller sensor length, an increased sensitivity of the sensor, and an overall higher transmission. The latter is limited, since the inner plasmon mode is propagating a high index region its intrinsic loss will always be higher than the loss of the external plasmon mode. E.g. for a wavelength of 1.55 μm, and a refractive index of 1.2, the loss of the external plasmon mode is equal to 0.04 dB/μm while the loss of the internal plasmon mode equals 1.79 dB/μm). Because of this the coupling to the inner mode should always be greater than the coupling to the outer mode.

FIG. 7 illustrates a schematic representation of the shift in resonance wavelength as a function of the thickness of the adsorbed layer. It illustrates the possibility to determine the thickness of the absorbed layer, according to an example of an embodiment of the present invention.

By way of example, the present invention not being limited thereto, a number of experimental and simulation results are provided, illustrating some features and advantageous of embodiments according to the present invention. In the present examples, the experimental set-up used for obtaining these results comprises a tuneable laser source, having an output power of 1 to 4 mW, a wavelength range between 1500 nm and 1600 nm and a wavelength resolution of 1 pm. For detection, a dual channel mainframe power detector was used. Laser light was coupled in and out of the structure using single mode optical fibres. Different types of coupling where used, i.e. either vertical coupling or horizontal coupling. In vertically coupling use is made of grating couplers and standard cleaved fibres. This type of coupling is relatively easy as the alignment of the end facet of the fibre and the grating are not that critical. Nevertheless, it has the disadvantage of being wavelength dependent, i.e. the grating does not couple each wavelength in the waveguide with the same efficiency. A second possibility is horizontal coupling, wherein the samples under test are cleaved and the wave guide is aligned with a tapered or lensed fibre for the incoupling and with a microscope objective for the outcoupling. The latter has the advantage that there is a wavelength independent coupling efficiency but the disadvantage that aligning a fibre with a very small waveguide is quite difficult to do.

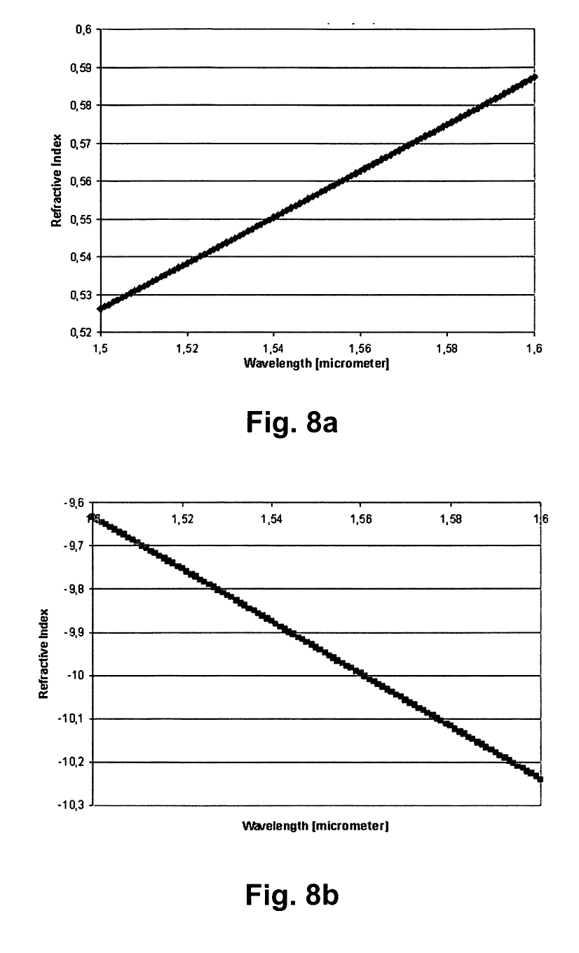

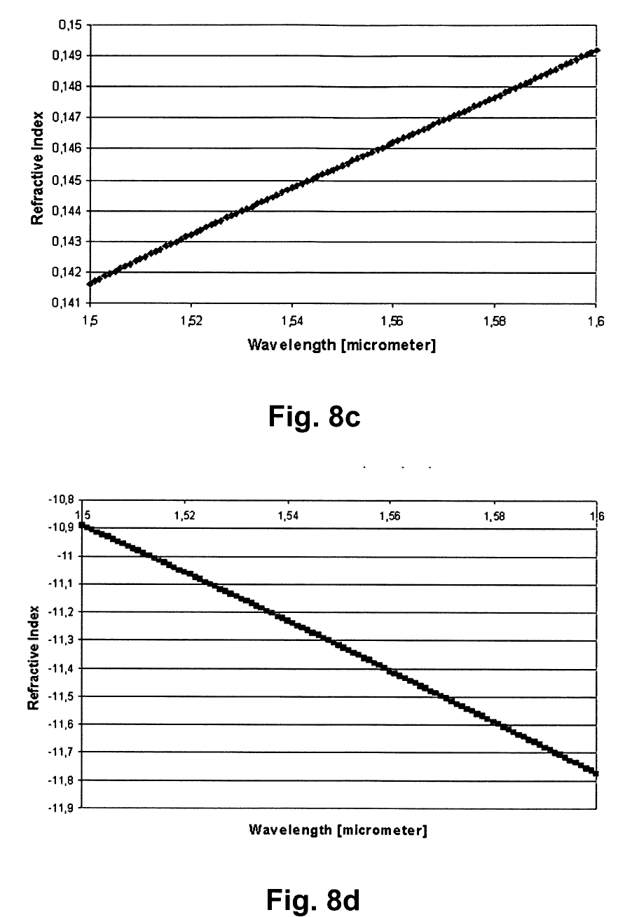

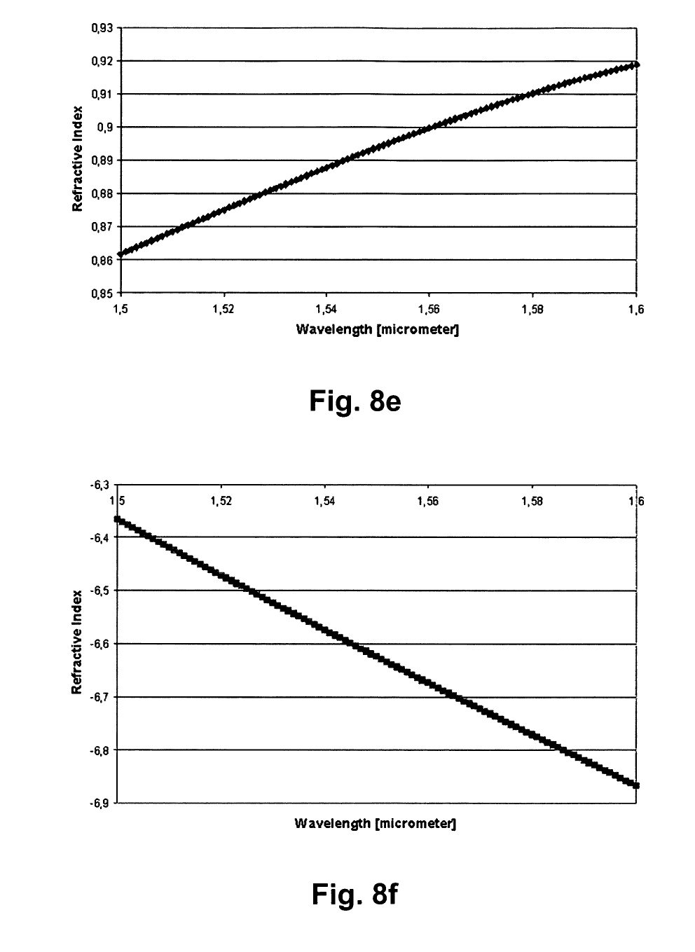

The set-up used in the present example is a Mach Zehnder Surface Plasmon Interferometer. For the simulations, refractive index from Palik “Handbook of optical constants of solids”, Academic Press, 1998 is used. FIG. 8a to FIG. 8f illustrate the real part of the refractive index (FIG. 8a, FIG. 8c, FIG. 8e) and the imaginary part of the refractive index (FIG. 8b, FIG. 8d, FIG. 8f) for gold (FIG. 8a, FIG. 8b), silver (FIG. 8c, FIG. 8d) and cobaltdisilicide (CoSl₂) (FIG. 8e, FIG. 8f) respectively.

### EXAMPLE 1

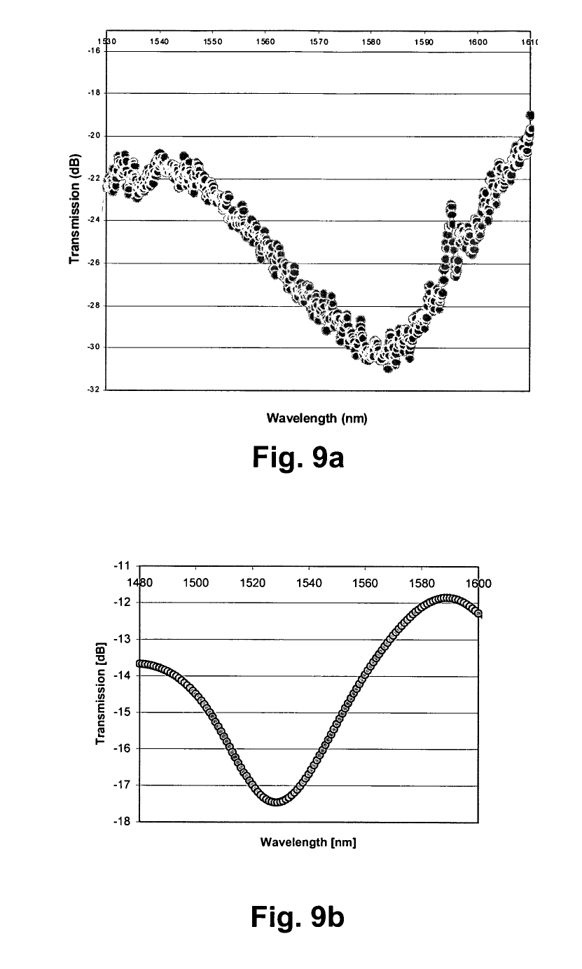

In a first example, a comparison is shown between an experimental result and simulation result for a system wherein a 5 μm strip of a gold layer is used. The strip is provided by etching in a silicon substrate with a depth of 80.62 nm and by providing a gold layer with a thickness of 49.74 nm. Measurements are performed in plain air. In FIG. 9a and 9b a comparison of the measured and calculated transmission as function of wavelength is shown. A good qualitative agreement can be seen between the measured and simulated results. The discrepancy between the results may be due to the fact that the etch process is not optimised for the silicon substrate used and the fact that small variations in the thickness and roughness of the gold layer may be present. The relative large measured losses are due to the roughness of the etching and the consequent roughness of the deposited gold layer.

A plurality of examples is provided illustrating simulated results obtainable with a Mach-Zehnder Surface Plasmon interferometer. Such a setup comprises an input waveguide for coupling the light into a sensing wave guide wherein interference will be generated. The resulting transmission spectra are discussed.

### EXAMPLE 2

Example 2 illustrates simulated results obtainable with a Mach-Zehnder Surface Plasmon interferometer using a sensor having a silicon-on-insulator (SOI) substrate with an embedded gold (Au) layer. The parameters of the different components of the input wave guide structure and sensing wave guide structure used in the simulation, as well as the length of the sensing section are indicated in table 1.

TABLE 1

| | Thickness (μm) | | Material | n |
|---|---|---|---|---|
| Input waveguide: | | | | |
| substrate | 4.0 | | Si | 3.45 |
| buried oxide | 2.0 | | SiO₂ | 1.45 |
| core | 0.22 | | Si | 3.45 |
| cladding | 5 | | H₂O | 1.33 |
| Sensing waveguide: | | | | |
| substrate | 4.0 | | Si | 3.45 |
| buried oxide | 2.0 | | SiO₂ | 1.45 |
| core | 0.135 | | Si | 3.45 |
| metal layer | 0.060 | | Au | FIG. 8a, 8b |
| cladding | 5 | | H₂O | 1.33 |
| length sensing section | 8.639 | μm | | |

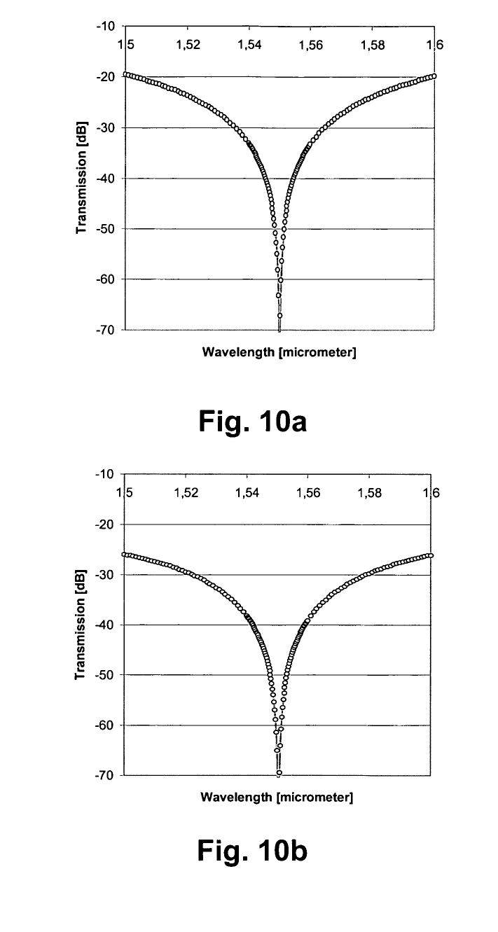

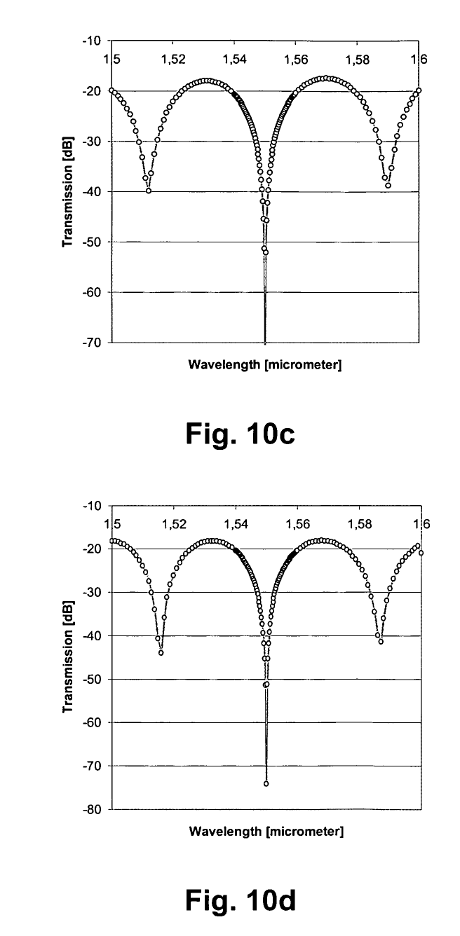

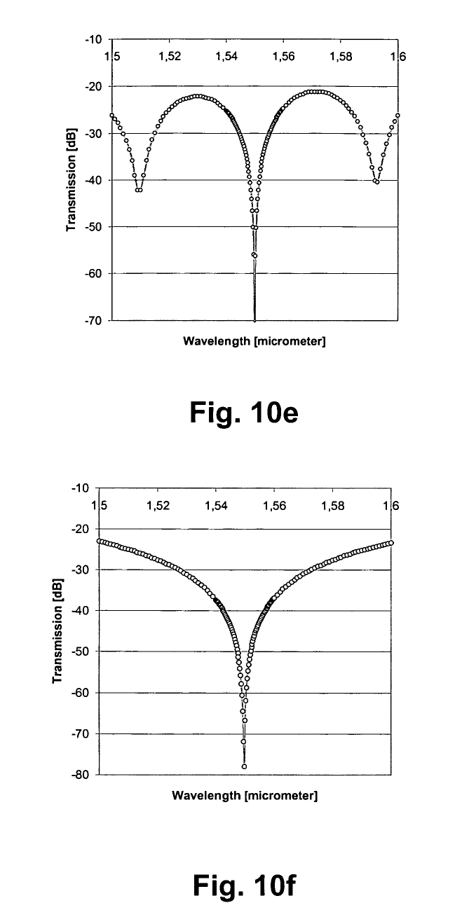

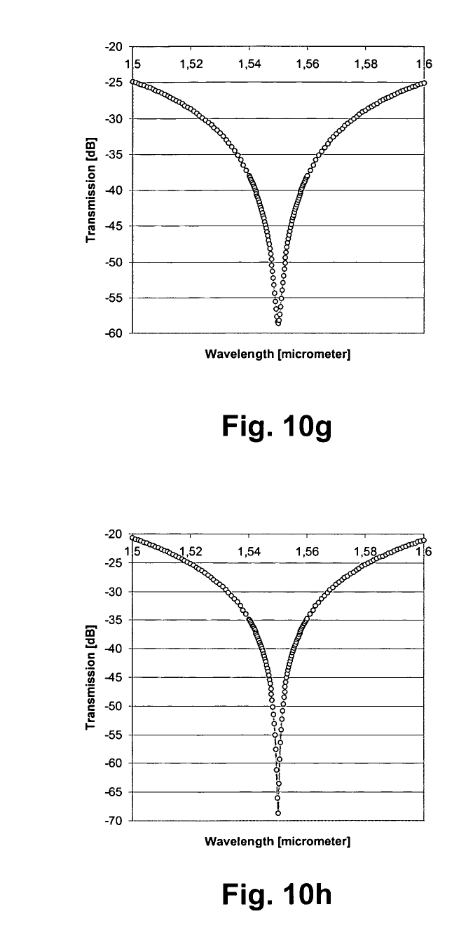

FIG. 10a illustrates the obtained transmission spectrum through the structure, indicated in dB, as function of the wavelength, indicated in μm. A clear destructive interference peak can be seen in the spectrum around 1550 nm.

### EXAMPLE 3

Example 3 illustrates a simulated result for a system as shown in the second example, whereby the Si core has a thickness of 0.129 μm, the cladding is 5 μm thick and comprises air (refractive index 1) and the length of the sensing section is 13.145 μm. The latter allows to illustrate the effect of changing the length of the sensing section and the cladding material, resulting in a transmission spectrum as shown in FIG. 10b. In other words, the device can be adapted and/or optimised for sensing in a different media. In the present example, the device is adapted for sensing in air media, more than in aqueous environments. The length of the sensing sections used depends on the material system and the refractive index at which the interference minimum is to be detected as is explained above. As a refractive index of 1 is used instead of 1.33 in the previous examples, a different sensing length is applied.

### EXAMPLE 4

Example 4 illustrates simulated results obtainable with a Mach-Zehnder Surface Plasmon interferometer using a sensor having a silicon-on-insulator substrate with an embedded silver layer. The parameters of the different components of the input wave guide structure and sensing wave guide structure used in the simulation, as well as the length of the sensing section are indicated in table 2.

TABLE 2

| | Thickness (μm) | | Material | n |
|---|---|---|---|---|
| Input waveguide: | | | | |
| substrate | 4.0 | | Si | 3.45 |
| buried oxide | 2.0 | | SiO₂ | 1.45 |
| core | 0.22 | | Si | 3.45 |
| cladding | 5 | | H₂O | 1.33 |
| Sensing waveguide: | | | | |
| substrate | 4.0 | | Si | 3.45 |
| buried oxide | 2.0 | | SiO₂ | 1.45 |
| core | 0.158 | | Si | 3.45 |
| metal layer | 0.060 | | Ag | FIG. 8c, 8d |
| cladding | 5 | | H₂O | 1.33 |
| length sensing section | 60.048 | μm | | |

FIG. 10c illustrates the obtained transmission spectrum through the structure, indicated in dB, as function of the wavelength, indicated in μm. Three peaks can be identified. These peaks are due to destructive interference. The device has been optimized for having the largest ‘peak’ at a wavelength of 1550 nm. The two other peaks occuring at shorter or larger wavelength are also due to destructive interference, whereby the distance between the different interference minima for the presently used material system is such that these side peaks are visible in the illustrated spectrum. The smaller intensity is caused by the fact that the optical power from the two modes causing the interference to be not balanced and resulting in an interference pattern being less pronounced for these peaks. The fact that only for some materials the side peaks are visible in the spectrum is due to the fact that the free-spectral range (the distance between different interference minima) is a function of the refractive index of the material system in question, so for each material system the FSR changes . . . so for some materials systems the secondary peaks fall within the 1500-1600 nm range, for others the secondary peaks are outside of the 1500-1600 nm range. This example illustrates that other types of metal layers can be used.

### EXAMPLE 5

Example 5 illustrates simulated results obtainable with a Mach-Zehnder Surface Plasmon interferometer using a sensor having a silicon-on-insulator substrate with an embedded silver layer as described in example 4, wherein the core thickness and the length of the sensing section is different, i.e. the core being 0.120 μm thick and the length of the sensing section being 41.869 μm thick. FIG. 10d illustrates the obtained transmission spectrum, indicated in dB, as function of the wavelength, indicated in ∥m. Three peaks can be identified. It can be seen that the resonance wavelength occurs at 1350 nm instead of 1550 nm. Depending on the particular properties of the materials and design selected, the resonance wavelength can be quite easily shifted towards higher or lower wavelengths than 1550 nm. Again, the length is selected as function of the wavelength at which destructive interference, so minimal transmission is to be observed.

### EXAMPLE 6

Example 6 illustrates simulated results obtainable with a Mach-Zehnder Surface Plasmon interferometer using a sensor having a silicon-on-insulator substrate with two embedded layers, i.e. a gold layer and a silver layer. The parameters of the different components of the input wave guide structure and sensing wave guide structure used in the simulation, as well as the length of the sensing section are indicated in table 3.

TABLE 3

| | Thickness (μm) | | Material | n |
|---|---|---|---|---|
| Input waveguide: | | | | |
| substrate | 4.0 | | Si | 3.45 |
| buried oxide | 2.0 | | SiO₂ | 1.45 |
| core | 0.22 | | Si | 3.45 |
| cladding | 5 | | H₂O | 1.33 |
| Sensing waveguide: | | | | |
| substrate | 4.0 | | Si | 3.45 |
| buried oxide | 2.0 | | SiO₂ | 1.45 |
| core | 0.193 | | Si | 3.45 |
| metal layer 1 | 0.030 | | Au | FIG. 8a, 8b |
| Metal layer 2 | 0.030 | | Ag | FIG. 8c, 8d |
| cladding | 5 | | H₂O | 1.33 |
| length sensing section | 62.208 | μm | | |

FIG. 10e illustrates the obtained transmission spectrum through the structure, 5 indicated in dB, as function of the wavelength, indicated in μm. Three peaks can be seen in the spectrum. It is an advantage of using a bimetallic layer that losses of the bottom surface mode can be reduced.

### EXAMPLE 7

Example 7 illustrates simulated results obtainable with a Mach-Zehnder Surface Plasmon interferometer using a sensor having a silicon-on-insulator substrate with an embedded cobaltdisilicide (CoSi₂) layer. The parameters of the different components of the input wave guide structure and sensing wave guide structure used in the simulation, as well as the length of the sensing section are indicated in table 4.

TABLE 4

| | Thickness (μm) | | Material | n |
|---|---|---|---|---|
| Input waveguide: | | | | |
| substrate | 4.0 | | Si | 3.45 |
| buried oxide | 2.0 | | SiO₂ | 1.45 |
| Core | 0.22 | | Si | 3.45 |
| cladding | 5 | | H₂O | 1.33 |
| Sensing waveguide: | | | | |
| substrate | 4.0 | | Si | 3.45 |
| buried oxide | 2.0 | | SiO₂ | 1.45 |
| Core | 0.092 | | Si | 3.45 |
| layer | 0.128 | | CoSi₂ | FIG. 8e, 8f |
| cladding | 5 | | H₂O | 1.33 |
| length sensing section | 1.258 | μm | | |

FIG. 10f illustrates the obtained transmission spectrum through the structure, indicated in dB, as function of the wavelength, indicated in μm. Three peaks can be identified. This example illustrates that other types, i.e. non metal layers, of materials can be used as layer for generating, supporting or propagating the interface modes. It thereby is to be noticed that silicides have a lot of common properties with metal layers. The layer is therefore also capable of sustaining surface plasmon modes at its surface. The present example supports the fact that no real metal layer is required but that any layer allowing to guide surface modes can be used. It is an advantage that very short sensing sections can be made that still allow to obtain an appropriate measurement result.

### EXAMPLE 8

Example 8 illustrates simulated results obtainable with a Mach-Zehnder Surface Plasmon interferometer using a sensor having an Indium Phosphide membrane deposited on a benzo-cyclo-butane (BCB) substrate with an embedded gold (Au) layer. The parameters of the different components of the input wave guide structure and sensing wave guide structure used in the simulation, as well as the length of the sensing section are indicated in table 5.

TABLE 5

| | Thickness (μm) | | Material | n |
|---|---|---|---|---|
| Input waveguide: | | | | |
| substrate | 5 | | BCB | 1.45 |
| Core | 0.300 | | InP | 3.17 |
| cladding | 5 | | H₂O | 1.33 |
| Sensing waveguide: | | | | |
| substrate | 5 | | BCB | 1.45 |
| Core | 0.189 | | InP | 3.17 |
| layer | 0.06 | | Au | FIG. 8a, 8b |
| cladding | 5 | | H₂O | 1.33 |
| length sensing section | 19.745 | μm | | |

FIG. 10g illustrates the obtained transmission spectrum through the structure, indicated in dB, as function of the wavelength, indicated in pm. One absorption peak can be identified. This example illustrates that with other materials the same design can be used to make a surface mode interferometer.

### EXAMPLE 9

Example 9 illustrates simulated results obtainable with a Mach-Zehnder Surface Plasmon interferometer using a sensor having an Indium Phosphide substrate being a heterostructure with an Indium Gallium Arsenide Phosphide (InGaAsP) core (Q1.22) with an embedded gold (Au) layer. The parameters of the different components of the input wave guide structure and sensing wave guide structure used in the simulation, as well as the length of the sensing section are indicated in table 6.

TABLE 6

| | Thickness (μm) | | Material | n |
|---|---|---|---|---|
| Input waveguide: | | | | |
| substrate | 5 | | InP | 3.17 |
| core | 0.522 | | InGaAsP | 3.37 |
| cladding | 5 | | H₂O | 1.33 |
| Sensing waveguide: | | | | |
| substrate | 5 | | InP | 3.17 |
| core | 0.061 | | InGaAsP | 3.37 |
| layer | 0.06 | | Au | FIG. 8a, 8b |
| cladding | 5 | | H₂O | 1.33 |
| length sensing section | 8.413 | μm | | |

FIG. 10h illustrates the obtained transmission spectrum through the structure, indicated in dB, as function of the wavelength, indicated in μm. One absorption peak can be identified. This example illustrates that a different material system can be used for the device. The index contrast between the core and cladding layer is relatively small, indicating that high-index contrast is not absolutely necessary, but that it assists in obtaining good resonance.

It is an advantage of detection systems according to embodiments of the present invention may be e.g. up to two orders of magnitude smaller than typical integrated SPR sensors as known from prior art. It is an advantage that sensing regions in the detection systems having a length of several micrometers should suffice, whereas traditional surface plasmon sensors require several millimeters. The sample width may e.g. be in the order of 10 micrometer, although the invention is not limited thereto. The aspect ratio between the thickness of the waveguide and the width of the waveguide may be sufficiently large to consider the waveguide as infinitely wide. Nevertheless, the invention is not restricted to devices wherein the waveguide may be considered as infinitely wide.

The latter is obtained by integration of the metal layer in a high-index contrast material system.

It is an advantage of detection systems according to embodiments of the present invention that the systems are highly tunable, thereby being a good candidate for a vast number of applications

It is an advantage of detection systems according to embodiments of the present invention that the sensitivity of the systems may be of the same order of magnitude as current integrated surface plasmon sensors, while the overall size of the detection region may be substantially smaller.

It is an advantage of detection systems according to embodiments of the present invention that these may be based on silicon-on-insulator devices, which allows to benefit from well established SOI fabrication schemes, such as Deep-UV lithography. This allows that such devices can easily be fabricated with a very high throughput. Such devices based on deep-UV lithography processes may be subject to further post-processing, after the deep UV lithography processing steps. It is an advantage of embodiments of the present invention that devices and methods based on surface plasmon resonance are obtained as the high sensitivity of this technique to surface phenomena makes it ideal for use in real-time and label-free biosensors where very small changes in refractive index must be detected.

It is an advantage of some embodiments of the present invention that a fully integrated surface plasmon lab-on-chip solution is provided.

While the invention has been shown and described with reference to preferred embodiments, it will be understood by those skilled in the art that various changes or modifications in form and detail may be made without departing from the scope of this invention. More particularly, although the present invention comprises an embodiment related to a detection system, the present invention furthermore relates to a cartridge for use in a detection system, whereby the cartridge can be fitted in the detection system and may be disposable. Such a cartridge typically comprises a substrate and layer for generating, supporting or propagating surface modes and optionally may comprise couplers or means for in and/or outcoupling of irradiation from an external irradiation source and/or to an external detector.

1. An optical detection system (100) for detecting biological, chemical or bio-chemical particles, the optical detection system (100) comprising a surface mode interference means,
wherein the surface mode interference means comprises a layer (102) and wherein the surface mode interference means is adapted to create an interference effect between optical interface modes of an irradiation beam in said layer to detect optical changes in the vicinity of the layer (102) or changes of thickness of adsorbed material at the interface between the material and the layer.

2. An optical detection system (100) according to claim 1, wherein the surface mode interference means is a surface plasmon resonance means.

3. An optical detection system (100) according to any of claims 1 to 2, wherein the layer (102) is a metal layer.

4. An optical detection system (100) according to any of claims 1 to 3, wherein the optical interface modes comprise at least two optical interface modes.

5. An optical detection system (100) according to any of claims 1 to 4, wherein said layer (102) is a gold layer.

6. An optical detection system (100) according to any of claims 1 to 4, wherein said layer (102) is a silicide.

7. An optical detection system (100) according to any of claims 1 to 6, wherein said optical interface modes are decoupled optical interface modes of said layer (102).

8. An optical detection system (100) according to claim 7, wherein the optical interface modes comprise at least an optical interface mode at a first side of the layer (102) and an optical interface mode at a second side of the layer, opposite to the first side of the layer (102).

9. An optical detection system (100) according to any of claims 1 to 8, the system (100) comprising a waveguide made of high refractive index material having first regions and a second region, whereby the layer is in close proximity with a second region of the waveguide.

10. An optical detection system (100) according to claim 9, wherein the layer (102) is at least partly embedded in a second region of the waveguide.

11. An optical detection system (100) according to claim 10, wherein the layer (102) is completely embedded in the second region of the waveguide.

12. An optical detection system (100) according to claim 11, wherein the surface of the layer (102) is in line with the surface of said waveguide.

13. An optical detection system (100) according to any of claims 9 to 12, wherein said waveguide made of high refractive index material is a silicon waveguide.

14. An optical detection system (100) according to claim 13, wherein said silicon waveguide is part of a silicon on insulator structure.

15. An optical detection system (100) according to any of claims 9 to 14, wherein mode cut-off is induced in the waveguide.

16. An optical detection system (100) according to claim 15, wherein the mode cut-off in the waveguide results in said second region of the waveguide having no own propagating mode near the layer (102).

17. An optical detection system (100) according to any of claims 9 to 16, wherein coupling loss between first regions and second region of the waveguide are lower than −15 dB, preferably lower than −12 dB, more preferably lower than −10 dB, even more preferably lower than −8 dB.

18. An optical detection system (100) according to claim 17, the layer (102) having a surface suitable for being contacted with a sample, wherein the coupling loss to an optical interface mode at the surface opposite to the surface suitable for being contacted with a sample is less than −7 dB, preferably less than −6 dB, more preferably less than −5 dB.

19. An optical detection system (100) according to any of claims 1 to 18, the optical detection system furthermore comprising an irradiation source (108) for generating an irradiation beam and/or a detector (110) for detecting said interference of said optical interface modes.

20. A method for detecting biological, chemical or bio-chemical particles, the method comprising
bringing one side of a layer (102) in contact with a sample (106)
creating interfering interface modes of an irradiation beam in said layer (102)
deriving from said interfering optical interface modes a presence of biological, chemical or biochemical particles in the vicinity of said layer (102).

21. A method according to claim 20, wherein said layer (102) is a metal layer.

22. A method for detecting according to any of claims 20 to 21, wherein creating interfering optical interface modes of an irradiation beam in said layer (102) comprises
providing an irradiation beam in a waveguide comprising said layer (102) and
generating decoupled optical interface modes of said irradiation beam in said layer (102).

23. A method for detecting according to claim 22, the method further comprising
providing propagation mode cut off in regions of the wave guide where optical interface modes are generated.

24. A method for detecting according to any of claims 20 to 23, the method comprising
coupling an irradiation beam propagation mode to decoupled optical interface modes with a coupling loss of less than −15 dB, preferably less than −12 dB, more preferably less than −10 dB, even more preferably less than −8 dB.

25. A method for setting up an optical detection system (100), the optical detection system (100) comprising a surface mode interference means having a layer (102), the method comprising
selecting design parameters of the surface mode interference means to generate an interference effect between optical interface modes of the layer (102).

26. A method for setting up according to claim 25, wherein said design parameters comprise at least one of a material type of the layer (102), a thickness of a layer cladding region, a length of a layer cladding region, embedding the layer (102) more or less in a high refractive index material, a material type of said high refractive index material, whether or not a grating is applied to reduce penetration depth of the optical surface mode in the sample medium.

27. A method for setting up according to any of claims 25 to 26, wherein said design parameters are selected in order to tune to a specific wavelength to be used.

28. A method for setting up according to any of claims 25 to 27, wherein said design parameters are selected in order to tune for a specific refractive index range for a sample to be detected.

29. A computer program product for executing a method as claimed in any of claims 25 to 28.

30. A machine readable data storage device storing the computer program product of claim 29.

31. Transmission of the computer program product according to claim 29 over a local or wide area telecommunications network.

32. A cartridge for use in an optical detection system for detecting biological, chemical or bio-chemical particles, the cartridge comprising a surface mode interference means,
wherein the surface mode interference means comprises a layer and wherein the surface mode interference means is adapted to create an interference effect between optical interface modes of an irradiation beam in said layer (102) to detect optical changes in the vicinity of the layer (102) or changes of thickness of adsorbed material at the layer (102).
